(19) United States
(12) Patent Application Publication
(10) Pub. No.: US 2024/0014689 A1
(43) Pub. Date: Jan. 11, 2024

(54) WIRELESSLY POWERED ELECTRIC ACTUATION OF PARTICLES AND MOLECULES

(71) Applicant: REGENTS OF THE UNIVERSITY OF MINNESOTA, (US)

(72) Inventors: Sang-Hyun Oh, Minneapolis, MN (US); Christopher T. Ertsgaard, Minneapolis, MN (US)

(21) Appl. No.: 18/037,395

(22) PCT Filed: Nov. 16, 2021
(86) PCT No.: PCT/US2021/059507

§ 371 Date: May 17, 2023

Related U.S. Application Data
(60) Provisional application No. 63/114,646, filed on Nov. 17, 2020.

(51) Int. Cl. H02J 50/12; G01N 27/447

(52) U.S. Cl. CPC H02J 50/12; G01N 27/44713; G01N 27/4473

(57) ABSTRACT

A wireless circuit including an electrode array with a nanoscale dielectric disposed between two electrodes allows for wirelessly powered manipulation of particles in a liquid solution, air, or gaseous media via dielectrophoretic forces. The electrode array includes a first electrode, a second electrode, and a nanoscale dielectric layer between the first and second electrode. An inductive coupler is operatively coupled to the electrode array and configured to receive wireless power or wireless signals.

### CROSS-REFERENCE TO RELATED APPLICATION

This application claims priority to U.S. Provisional Patent Application No. 63/114,646, filed Nov. 17, 2020, which is incorporated herein by reference.

### TECHNICAL FIELD

The present disclosure relates generally to wirelessly powered manipulation of particles in liquid solution, air, or gaseous media.

### BACKGROUND

Dielectrophoresis is a phenomenon by which a force is exerted on a particle when the particle is subjected to a non-uniform electric field. Dielectrophoretic actuation may allow for a collection of particles to be suspended using electrical forces. The effect of dielectrophoretic actuation may not require the particle to have a particular charge, magnetic moment, or chemical moiety. Instead, dielectrophoretic actuation induces local dipole moments about each of the suspended particles to collect and position the particles within fringe electric field regions around an electrode.

The trapped, collected, or positioned particles may be detected or passively measured based on a change in reflected impedance of the electrode. However, dielectrophoresis typically requires a large voltage to collect, position, or trap suspended particles and requires a subsequent smaller voltage to perform sensitive impedance measurements. Filtering and amplification may be necessary to perform the impedance measurements.

### SUMMARY

The present disclosure describes, among other things, a strategy for wirelessly powered, manipulation of particles via dielectrophoretic forces that may be driven using, low-power sources. In some aspects described herein, nano-spaced electrodes that are designed for surface coverage are utilized to sustain strong electric fields for manipulating particles. Stable capacitance for resonant inductive coupling may be obtained, which may be used to power the dielectrophoretic device via wireless power transfer (WPT). Accordingly, in some aspects, the devices described herein combine an efficient nanogap electrode array with the efficiency of resonant inductive coupling.

In general, in one aspect, the present disclosure describes a wireless circuit comprising an electrode array and an inductive coupler. The electrode array comprises a first electrode, a second electrode, a dielectric layer between the first and second electrode having a nanoscale or microscale width. The inductive coupler is operatively coupled to the electrode array and configured to receive wireless power or wireless signals.

In one or more embodiments, the second electrode comprises a first major surface and a second major surface. The second major surface is disposed on the nanoscale dielectric layer. The second electrode comprises a plurality of apertures extending from the first major surface to the second major surface, the plurality of apertures having a nanoscale or microscale width. In one or more embodiments, the first and second electrode are coplanar, interdigitated, or both. In one or more embodiments, the first and second electrode are vertically stacked.

In one or more embodiments, the nanoscale dielectric layer has a thickness of 1 nanometer to less than 1 micrometer. In one or more embodiments, the nanoscale dielectric layer has a thickness of 5 nanometers to 100 nanometers. In one or more embodiments, the nanoscale dielectric layer has a thickness of 10 nanometers to 20 nanometers.

In one or more embodiments, the nanoscale dielectric layer has a thickness of 3.45 angstroms to 1 nanometer. In one or more embodiments, the nanoscale dielectric layer has a thickness of 3.45 angstroms to 100 angstroms. In one or more embodiments, the nanoscale dielectric layer has a thickness of 3.45 nanometers to 10 angstroms.

In one or more embodiments, each of the plurality of apertures has a width or diameter of 10 nanometers to 100 micrometers. In one or more embodiments, each the plurality of apertures has a width or diameter of 900 nanometers to 50 micrometers. In one or more embodiments, each of the plurality of apertures has a width or diameter of 1 micrometer to 10 micrometers.

In one or more embodiments, the wireless circuit further includes a tuning capacitor or inductor. In one or more embodiments, the wireless circuit is disposed in a device. In one or more embodiments, the device is an implantable medical device. In one or more embodiments, the device is a microwell.

In one or more embodiments, the dielectric layer is an air gap.

In general, in another aspect, the present disclosure describes a method comprising disposing a first electrode comprising a first major surface and a second major surface, disposing a nanoscale dielectric layer on the first major surface of the first electrode, disposing a second electrode on the nanoscale dielectric layer, the second electrode comprising a first major surface, a second major surface, and operatively coupling an inductive coupler between the first electrode and the second electrode.

In general, in another aspect, the present disclosure describes a method comprising disposing a first electrode on a portion of a substrate, disposing a nanoscale dielectric layer on another portion of the substrate and the first electrode, disposing a second electrode on the nanoscale dielectric layer such that the first and second electrodes are coplanar with each other and the nanoscale dielectric layer forms a nanoscale gap between the first and second electrodes, and operatively coupling an inductive coupler between the first electrode and the second electrode.

In one or more embodiments, the method further comprises forming a plurality of apertures through the second electrode, wherein the plurality of apertures extend from first major surface of the electrode to the second major surface of the second electrode, wherein the plurality of apertures have a nanoscale or microscale width. In one or more embodiments, the plurality of apertures are formed the first electrode, the dielectric layer, and the second electrode.

In one or more embodiments, the nanoscale dielectric layer is deposited using atomic layer deposition. In one or more embodiments, the nanoscale dielectric layer is deposited such that the nanoscale dielectric layer conformally coats the first electrode and the other portion of the substrate.

In one or more embodiments, the method further comprises removing excess material disposed on the nanoscale dielectric layer prior to operatively coupling the inductive coupler.

In one or more embodiments, forming the plurality of apertures through the second electrode comprises defining an aperture pattern using photolithography, and etching the plurality of apertures.

In one or more embodiments, the electrodes are interdigitated.

In one or more embodiments, the method further comprises electrically coupling a tuning capacitor or inductor to the first and second electrode.

In general, in another aspect, the present disclosure describes a method comprising providing wireless power to an inductive circuit of a wireless circuit, the wireless circuit comprising the inductive circuit operatively coupled to a first electrode and to a second electrode, the first electrode and second electrode separated by a nanoscale or microscale dielectric layer or gap, generating an electric field using the wireless circuit, and moving one or more particles using the generated electric field.

In one or more embodiments, moving one or more particles comprises the trapping or repelling the one or more particles. In one or more embodiments, moving the one or more particles comprising stirring the one or more particles.

In one or more embodiments, the second electrode comprises a first major surface and a second major surface and comprises a plurality of apertures extending from the first major surface to the second major surface, the plurality of apertures having a nanoscale or microscale width. In one or more embodiments, the first electrode and the second electrode are coplanar, interdigitated, or both.

In one or more embodiments, the method further includes wirelessly sensing particles using a wireless sensing device. The wirelessly sensed particles may include trapped particles. The wireless sensing device may provide the wireless power to the wireless circuit.

### BRIEF DESCRIPTION OF THE DRAWINGS

FIG. 1A is a cross-sectional view of an embodiment of a wireless circuit including an electrode array.

FIG. 1B is a top down view of an electrode of the wireless circuit of FIG. 1.

FIGS. 2A-2E are cross-sectional views of an exemplary process for fabricating the wireless device of FIG. 1A.

FIG. 3 is a cross-sectional view of another embodiment of a wireless circuit including a coplanar electrode array.

FIGS. 4A-4E are cross-sectional views of an exemplary process for fabricating the wireless device of FIG. 3.

FIG. 5 is a schematic circuit diagram depicting wireless power transfer from a device to a wireless circuit.

FIG. 6 is a graph of the complex Claussious-Mossoti factor (CMF) of Polystyrene beads in deionized water.

FIG. 7 is a graph of voltage as a function of frequency measured over a coplanar electrode array designed to resonate at 1 MHz.

FIG. 8 is a graph of voltage as a function of coil separation for non-resonant circuits and resonant circuits.

FIG. 9 is a simulation comparing the trapping radius for 200 nm Polystyrene particles using non-resonant and wireless circuits.

FIG. 10 is a set of microscopic images of a coplanar electrode array during wireless trapping of 1 micrometer, 200 nanometer, and 40 nanometer Polystyrene particles.

FIG. 11 is a graph depicting experimental results comparing maximal coil separation.

FIG. 12 is a graph depicting impedance as a function of frequency before and after trapping particles.

FIG. 13 is a graph depicting impedance over time during trap and release of particles.

FIG. 14 is a micro hole electrode array image and fluorescent images taken during wireless particle trapping.

FIG. 15 is a graph of particle counts taken from a 180×135 micrometer microscope field of view plotted as a function of time.

FIGS. 16 and 17 show active drug release using wireless circuits as described herein.

FIG. 18 shows a wireless circuit as described herein being used for the lining of inside microfluidic or liquid tubing.

FIG. 19 shows a wireless circuit as described herein being used in microwells.

FIG. 20 shows a wireless circuit as described herein being used in a stent.

FIG. 21 shows an example of a fabricated on-chip spiral inductor. A magnified view is depicted showing trace width W and spacing S design parameters.

FIG. 22 shows a bar graph showing the threshold voltage for trapping polystyrene (PS) beads in deionized (DI) water at 1 MHz.

FIGS. 23A and 23B show schematic drawings of an electrode array that includes apertures that extend through a first electrode, a dielectric layer, and a second electrode.

FIG. 24 shows a schematic circuit diagram of a wireless power transfer circuit.

FIG. 25 shows a non-linear least squares fit of the coupling coefficient for resonant and non-resonant wireless power transfer (WPT).

FIG. 26 shows an absolute particle velocity histogram.

The drawings in are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

An inductive coupler may be operatively coupled to an electrode array to provide wirelessly powered manipulation of particles (e.g., virus, bacteria, drug carrying capsules, etc.) in a liquid solution, air, or gaseous media via dielectrophoretic forces. Furthermore, such particles may be detected using a wireless device that supplies wireless power to the electrode inductive coupler and the electrode array. The particles may be detected based on an impedance change determined by the wireless device. Use of DEP to trap (e.g., collect, position, etc.) particles may position such particles within fringe fields near the electrodes. The trapped particles may change the dielectric environment within such fringe fields and cause a change in impedance that can be observed (e.g., measured) wirelessly. In other words, a wireless device can detect an impedance change caused by the trapped particles. Accordingly, a wireless (e.g., cable-free) collection and detection apparatus may be integrated with wireless devices for various applications including, for example, biosensing, wearable biotech, drug delivery, medical or environmental diagnostics, etc.

The electrode array may include two electrodes with a nanoscale dielectric layer between them. As used herein, “nanoscale” may refer to a width of 1 nanometer to less than 1 micrometer, preferably 5 to 100 nanometers, or more preferably 10 to 20 nanometers. In one or more embodiments, the electrodes of the electrode array may be coplanar and/or interdigitated. In one or more embodiments, the electrodes of the electrode array may be stacked. One electrode may include apertures with a nanoscale or microscale width or diameter. As used herein, “microscale” may refer to a width of 1 micrometer to less than 1 millimeter, preferably 1 to 100 micrometers, or more preferably 1 to 10 micrometers. In one or more embodiments, both electrodes may include apertures with a nanoscale or microscale width or diameter.

Wireless circuits as described herein, may use nanogap or nanoscale technology to confine radio-frequency (RF) energy for dielectrophoretic manipulation (i.e. trapping repelling, or stirring) of micrometer to nanometer sized particles using sub-volt signals held over large surface coverage via high-aspect ratio edges and 2 Dimensionally stacked arrays. Such wireless circuits using nano-RF focusing, only one low-volt signal may be necessary for simultaneous trapping and detection of suspended particles. Efficiency may be further enhanced when utilizing a resonant circuit in which the parasitic capacitance of the device is canceled by inductive reactance. Advantages may include an increased number of particles collected at lower voltages and increased sensitivity to impedance changes caused by trapped particles. Additionally, the same inductive coupler can be used for wireless power transfer, receiving data signals, or transmitting data signals. Because DEP operates within the RF regime, existing devices may be used to supply power to the wireless circuits described herein, for example, near field communication (NFC), amplitude modulated (AM) radio, and radio-frequency identification (RFID). Utilizing a nanogap or nanoscale electrode design as described herein, such RF confinement may provide seamless integration of low-power DEP with wireless power transfer to power particle collection and wirelessly detect trapped particles.

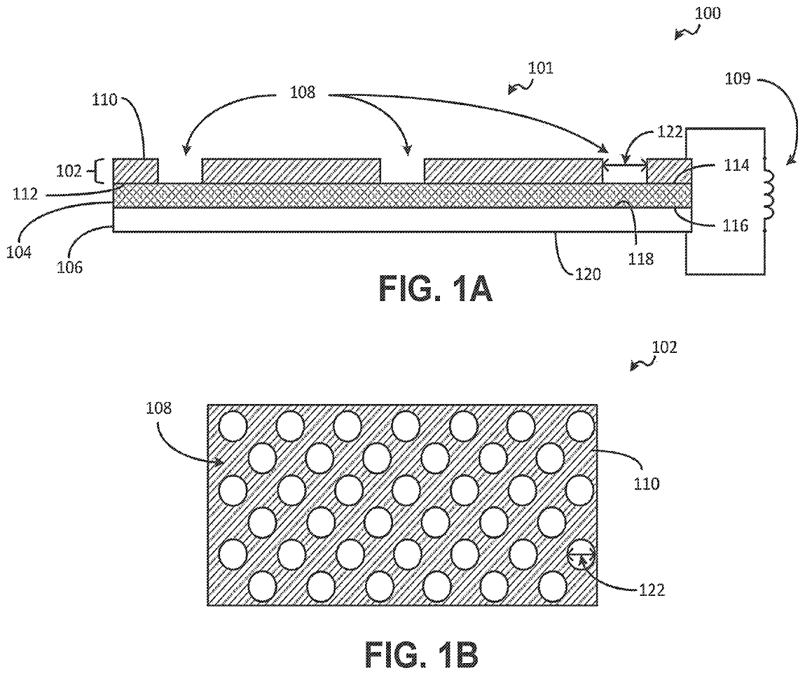

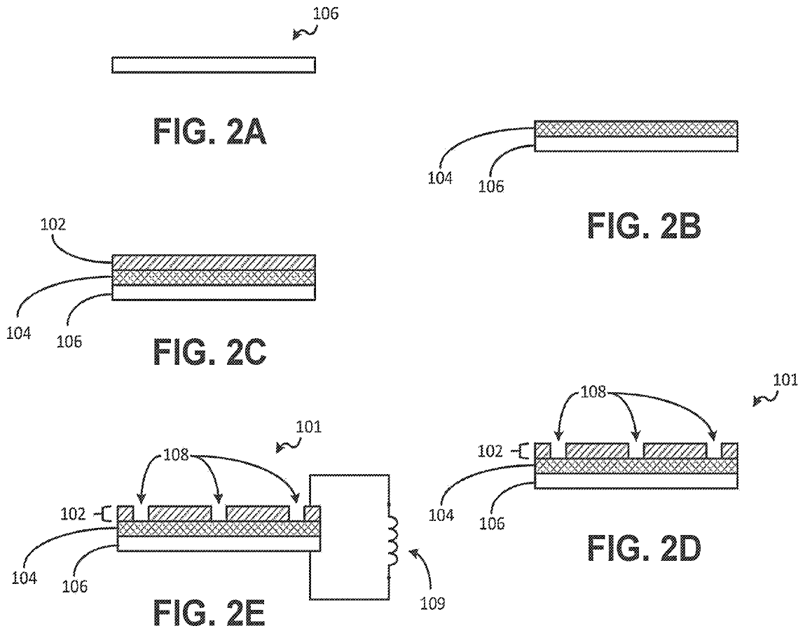

FIG. 1 shows a cross-sectional view of an embodiment of a wireless circuit 100. Wireless circuit 100 includes an electrode array 101 and an inductive coupler 109. The electrode array 101 includes electrode 102, an electrode 106, and a nanoscale dielectric layer 104 between the electrode 102 and the electrode 106, The inductive coupler 109 is operatively coupled to the electrode array 101 and configured to receive wireless power or wireless signals.

As shown in FIGS. 1A and 1B, the electrode 102 includes a major surface 110 and a major surface 112. The major surface 112 of the electrode 102 is disposed on the nanoscale dielectric layer 104. The electrode 102 includes apertures 108 that extend from the major surface 110 to the major surface 112. In other words, the apertures 108 are gaps or holes through the electrode 102. The apertures 108 have a width 122. The width 122 of the apertures 108 may be nanoscale or microscale in dimension. For example, the apertures 108 may have a width 122 of 500 nanometers to 100 micrometers, 900 nanometers to 50 micrometers, or 1 micrometer to 10 micrometers. The electrode 102 may include any suitable material or materials, for example, gold, silver, copper, chromium, titanium, tungsten, iron, doped semiconductor, graphene or other 2D material, indium tin oxide, or other conductive material. The electrode 102 may include any suitable size or shape. The electrode 102 may have any suitable thickness extending from the major surface 110 and the major surface 112, for example, the electrode 102 may have a thickness of 50 nanometers to 200 nanometers.

The electrode 106 includes a major surface 118 and a major surface 120. The electrode 106 may include any suitable material or materials, for example, gold, silver, copper, chromium, titanium, tungsten, iron, doped semiconductor, graphene or other 2D material, indium tin oxide, or other conductive material. The electrode may include any suitable size or shape. The electrode 106 may have any suitable thickness extending from the major surface 118 and the major surface 120, for example, the electrode 106 may have a thickness of 50 nanometers to 200 nanometers.

The nanoscale dielectric layer 104 is disposed between the electrodes 102, 106. The nanoscale dielectric layer 104 includes a major surface 114 and a major surface 116. The major surface 116 of the nanoscale dielectric layer 104 is disposed on the electrode 106. The major surface 114 of the nanoscale dielectric layer 104 is exposed through apertures 108. The nanoscale dielectric layer 104 defines a gap between the electrodes 102, 106. The nanoscale dielectric layer 104 may have any suitable thickness extending from the major surface 114 and the major surface 116, for example, the nanoscale dielectric layer 104 may have a thickness of 1 nanometer to 1 micrometer, 5 nanometers to 50 nanometers, or 10 nanometers to 20 nanometers. The nanoscale dielectric layer 104 may include in suitable material or materials, for example, alumina (Al₂O₃), titanium dioxide, silicon dioxide, glass, 2D materials or other dielectric material. The use of 2D materials may facilitate a thickness of the nanoscale dielectric layer 104 of a few angstroms. In some embodiments, the nanoscale dielectric layer 104 may have a thickness 3.45 angstroms to 1 nanometer, 3.45 angstroms to 100 angstroms, or 3.45 nanometers to 10 angstroms.

The inductive coupler 109 is operatively coupled to the electrodes 102, 106 of the electrode array 101. The inductive coupler 109 can include any suitable inductive components, for example, a wire coil, a flat spiral coil, a planar printed circuit board coil, 3D printed inductive coil, a clover-leaf resonator , microstrip, open stub or shunt stub transmission lines, ring or split-ring resonators, hairpin resonator, or other inductive component. The inductive coupler 109 may include any suitable conductive material or materials, for example, copper, silver, gold, or other conductive material. The inductive coupler 109 may be configured to receive wireless power from an external device. The inductive coupler 109 may be configured to transmit or receive wireless signals.

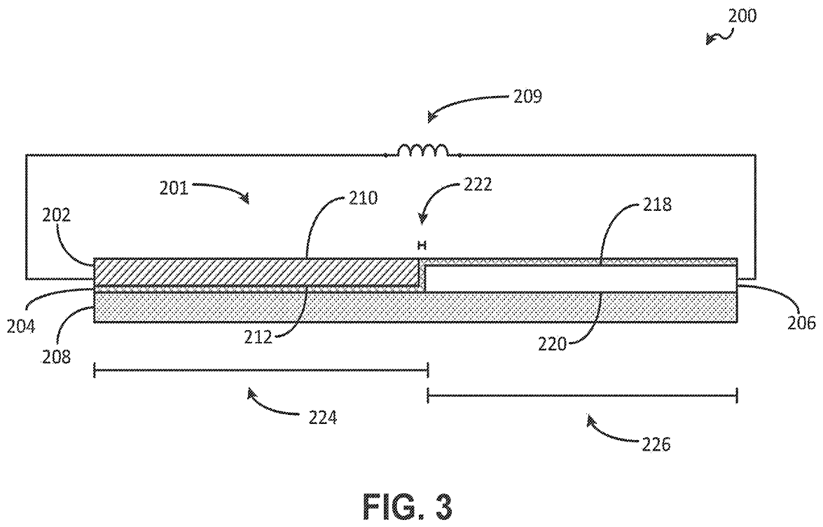

FIGS. 2A-2E are cross-sectional views of an exemplary process for fabricating the wireless device of FIG. IA. At FIG. 2A, the electrode 106 is disposed. The electrode 106 can be disposed using any suitable technique or techniques, for example, atomic layer deposition, sputtering, plating, chemical vapor deposition, thermal evaporation deposition, electron-beam evaporation deposition or other deposition technique. In one or more embodiments, the electrode 106 is disposed on a substrate. The substrate may include any suitable material or materials, for example, glass, ceramic, silicon, sapphire, or other non-conductive materials. In one or more embodiments, the substrate may be a flexible substrate. The flexible substrate may include any suitable material or materials such as, for example, conductive polymers (e.g., parylene, polyimide, polyaniline, polyethylene terephthalate, polyethylene naphthalate, polydimethylsiloxane, polyurethane), hydrogels, perovskites, organic semiconductors, thinned-amorphous silicon, or other flexible materials. The substrate may take on any suitable size or shape. The substrate may have a thickness of, for example, 200 micrometers to 800 micrometers, preferably 300 micrometers to 700 micrometers, more preferably 400 micrometers to 600 micrometers. In one or more embodiments, the shape of the electrode 106 is defined on the substrate using photolithography.

At FIG. 2B, the nanoscale dielectric layer 104 is disposed on the major surface 118 of the electrode 106. The nanoscale dielectric layer 104 can be disposed using any suitable technique or techniques, for example, atomic layer deposition, chemical vapor deposition, thermal evaporation deposition, electron-beam evaporation deposition, native oxide growth, dielectric sputtering, chemically bound polymers or self-assembled dielectric monolayers, dielectric nanoparticles, transfer of an insulative 2D material or other deposition technique. At FIG. 2C, the electrode 102 is disposed on the nanoscale dielectric layer 104. The electrode 102 can be disposed using any suitable technique or techniques, for example, atomic layer deposition, sputtering, plating, chemical vapor deposition, thermal evaporation deposition, electron-beam evaporation deposition or other deposition technique. At FIG. 2D, apertures 108 are formed through the electrode 102. The apertures 108 may be formed using any suitable technique or techniques, for example, photolithography, etching, drilling, lasering, or other material removal techniques.

In one or more embodiments, apertures 108 may be formed by defining an aperture pattern using photolithography on the nanoscale dielectric layer 104 prior to disposing the electrode 102. After disposing the electrode 102 a lift-off process may be used to form the apertures 108. Additionally, portions of the nanoscale dielectric layer 104 exposed through the apertures 108 may be etched.

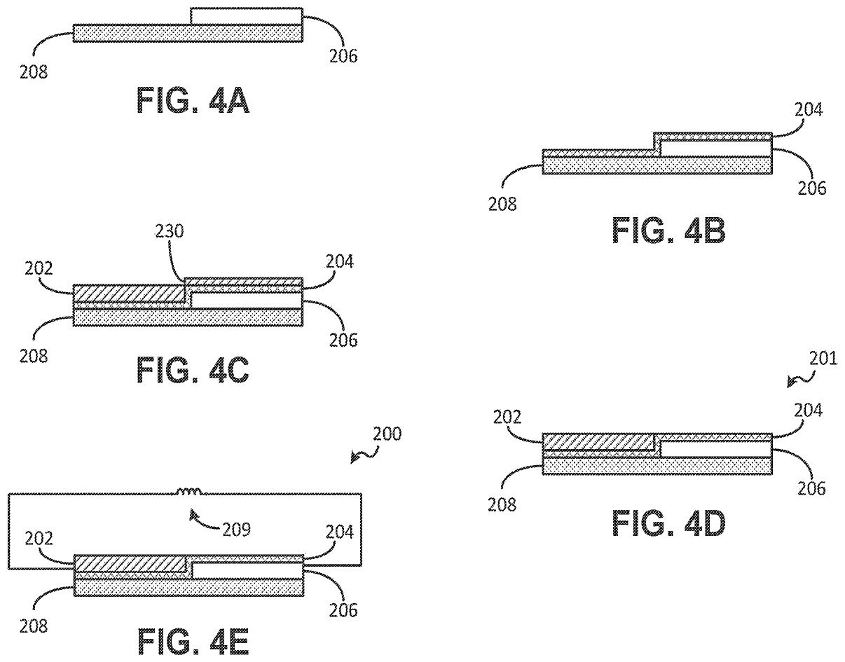

FIG. 3 shows a cross-sectional view of a wireless circuit 200 including a coplanar electrode array 201 and an inductive coupler 209 operatively coupled to the coplanar electrode array 201. The coplanar electrode array 201 includes a substrate 208, an electrode 202, an electrode 206, and a nanoscale dielectric layer 204 between the electrode 202 and the electrode 206, The inductive coupler 209 is operatively coupled to the coplanar electrode array 201 and configured to receive wireless power or wireless signals.

As shown in FIG. 3, the substrate includes portions 224, 226. The substrate 208 may include any suitable material or materials, for example, glass, ceramic, silicon, sapphire, or other non-conductive materials. In one or more embodiments, the substrate 208 may be a flexible substrate. The flexible substrate may include any suitable material or materials such as, for example, conductive polymers (e.g., parylene, polyimide, polyaniline, polyethylene terephthalate, polyethylene naphthalate, polydimethylsiloxane, polyurethane), hydrogels, perovskites, organic semiconductors, thinned-amorphous silicon, or other flexible materials. The substrate 208 may take on any suitable size or shape. The substrate 208 may have a thickness of, for example, 200 micrometers to 800 micrometers, preferably 300 micrometers to 700 micrometers, more preferably 400 micrometers to 600 micrometers.

The electrode 106 is disposed on portion 226 of the substrate 208. The electrode 106 includes a major surface 118 and a major surface 120. The electrode 106 may include any suitable material or materials, for example, gold, silver, copper, chromium, titanium, tungsten, iron, doped semiconductor, graphene or other 2D material, indium tin oxide, or other conductive material. The electrode may include any suitable size or shape. The electrode 106 may have any suitable thickness extending from the major surface 118 and the major surface 120, for example, the electrode 106 may have a thickness of 50 nanometers to 200 nanometers.

The electrode 202 includes a major surface 210 and a major surface 212. The major surface 212 of the electrode 202 is disposed on the nanoscale dielectric layer 204. The electrode 202 may include any suitable size or shape. The electrode 202 may have any suitable thickness extending from the major surface 210 and the major surface 212, for example, the electrode 202 may have a thickness of 50 nanometers to 200 nanometers. The electrode 202 is coplanar with the electrode 206. In other words, the major surfaces 210, 212 of electrode 202 do not face or overlap the major surfaces 218, 220 of electrode 206.

The nanoscale dielectric layer 204 is disposed on the portion 224 of the substrate 208 and electrode 206 such that the nanoscale dielectric layer 204 conformally coats the electrode 206 and the portion 224 of the substrate 208. In other words, the nanoscale dielectric layer 204 is disposed on the major surface 218 of the electrode 206 and a side of the electrode 206 that extends between the major surfaces 218, 220 of the electrode 206. The nanoscale dielectric layer is further disposed between the electrodes 202, 206. The nanoscale dielectric layer 204 defines a gap between the electrodes 202, 206. The nanoscale dielectric layer 204 may have any suitable thickness 222 extending between the electrodes 202, 206, for example, the nanoscale dielectric layer 204 may have a thickness 222 of 1 nanometer to 200 nanometers, 5 nanometers to 50 nanometers, or 10 nanometers to 20 nanometers. The nanoscale dielectric layer 204 may include in suitable material or materials, for example, alumina (Al₂O₃), titanium dioxide, silicon dioxide, 2D materials, glass, or other dielectric material.

The inductive coupler 209 is operatively coupled to the electrodes 202, 206 of the coplanar electrode array 201. The inductive coupler 209 can include any suitable inductive components, for example, a wire coil, a flat spiral coil, a planar printed circuit board coil, 3D printed inductive coil, a clover-leaf resonator , microstrip, open stub or shunt stub transmission lines, ring or split-ring resonators, hairpin resonator, or other inductive component. The inductive coupler 209 may include any suitable conductive material or materials, for example, copper, silver, gold, or other conductive material. The inductive coupler 209 may be configured to receive wireless power from an external device. The inductive coupler 209 may be configured to transmit or receive wireless signals.

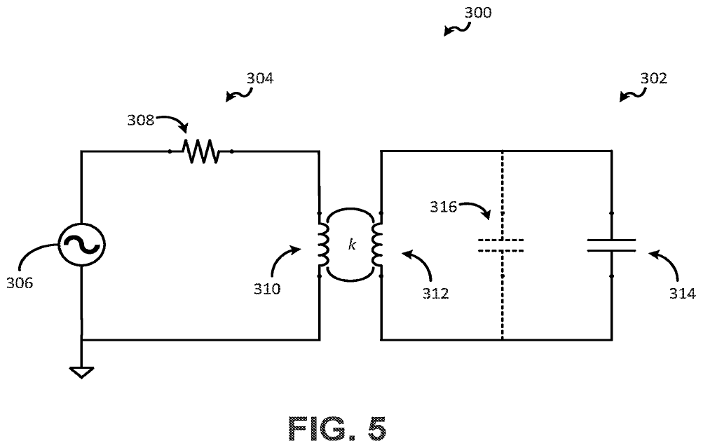

FIGS. 4A-4E are cross-sectional views of an exemplary process for fabricating the wireless circuit 200 of FIG. 3. At FIG. 4A, the electrode 206 is disposed on the substrate 208. The electrode 206 can be deposited using any suitable technique or techniques, for example, atomic layer deposition, sputtering, plating, chemical vapor deposition, electron-evaporation deposition, or other deposition technique. An edge of the electrode 206 may be defined prior to depositing the electrode using photolithography.

At FIG. 4B, the nanoscale dielectric layer 204 is disposed the portion 224 of the substrate 208 and the electrode 206. The nanoscale dielectric layer 204 can be disposed using any suitable technique or techniques, for example, atomic layer deposition, chemical vapor deposition, thermal evaporation deposition, electron-beam evaporation deposition, native oxide growth, dielectric sputtering, chemically bound polymers or self-assembled dielectric monolayers, dielectric nanoparticles, transfer of an insulative 2D material or other deposition technique. The nanoscale dielectric layer 204 may be disposed in a conformal layer.

At FIG. 4C, the electrode 202 is disposed on the nanoscale dielectric layer 204 such that the electrode 202 and the electrode 206 are coplanar with each other and the nanoscale dielectric layer 204 defines a nanoscale gap between the electrodes 202, 206. The electrode 202 can be disposed using any suitable technique or techniques, for example, atomic layer deposition, sputtering, plating, chemical vapor deposition, thermal evaporation deposition, electron-beam evaporation deposition or other deposition technique. In one or more embodiments, disposing the electrode 202 results in excess material 230 being disposed on the nanoscale dielectric layer 204. At FIG. 4D, any excess material 230 can be removed from the nanoscale dielectric layer 204. At FIG. 4E, the inductive coupler 209 is operatively coupled between the electrode 202 and the electrode 206.

Additional systems and methods for forming electrode arrays may be found in U.S. Pat. No. 9,777,372 and U.S. Publication Number 2018/0361400 which are hereby incorporated by reference in their entirety to the extent that they do not conflict with the present disclosure.

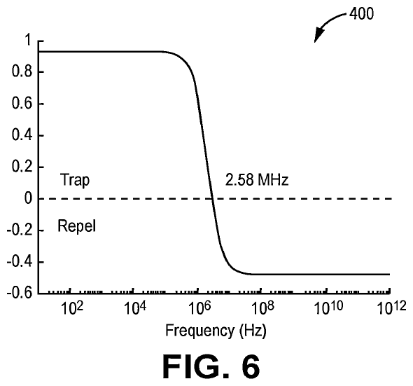

FIG. 5 is a schematic circuit diagram 300 depicting wireless power transfer from a device 304 to a wireless circuit 302. The wireless circuit 302 may be any suitable wireless circuit such as wireless circuits 100 and 200 of FIGS. 1A and 2.

The wireless circuit 302 includes inductive coupler 312 and electrode array 314. The wireless circuit 302 may optionally include a tuning capacitor 316. The tuning capacitor 316 may be used to tune a resonant frequency of the wireless circuit 302. The inductive coupler 312 may be configured to receive power, transmit wireless signals, or receive wireless signals.

The device 304 may be any suitable wireless device with wireless power transfer or sensing capabilities such as, for example, a smartphone, near-field communication (NFC), or radio frequency identification (RFID). The device 304 includes an oscillating power source 306, a load 308, and an inductive coupler 310. The inductive coupler 310 is configured to inductively couple to inductive coupler 312 of the wireless circuit 302 to provide power, transmit wireless signals, or receive wireless signals.

As described herein, wireless circuits can operate using low-power and low-voltage. As used herein “low-power” may refer to 50 milliwatts to 500 milliwatts. Resonant wireless circuits may have a power consumption of about 50 milliwatts to 150 milliwatts. Non-resonant wireless circuits may have a power consumption of 200 milliwatts to 500 milliwatts. As used herein low-voltage” may refer to voltages of 0.25 volts root mean squared (Vrms) to 3.5 Vrms.

Nano-Focusing for Efficient Dielectrophoretic Collection

Dielectrophoresis (DEP) as used herein refers to actuation particles within a dielectric medium by inducing a dipole about each particle via an oscillating electric field (i.e., an alternating current (AC) signal). If the frequency of the signal is such that this induced dipole has time to respond, the particle/dipole may migrate towards locations with high spatial variations in the electric field due to the unequal forces acting upon the two ends of the dipole. If the particle cannot respond with the AC frequency as compared to the surrounding medium, the surrounding liquid solution may fill such high electric field regions resulting in the particle being forced/rejected away. Whether a particle is forced toward or away from such electric field gradients may be determined based on the frequency dependent, complex Claussious-Mossoti factor (CMF).

If the real part of the CMF is positive (pDEP) the particles may migrate towards fringe Electric fields. If the real part of the CMF is negative (nDEP) the particles may be repelled from fringe Electric fields. The factor determining whether a particle experiences pDEP or nDEP for a given frequency is contained within the Claussious-Mossoti factor, f_{CM}*, (CMF) in which the angular frequency (ω) of the AC signal and the complex dielectric permittivity of a given particle (εₘ*) and the complex dielectric permittivity of the surrounding solution (εₚ*) determine the CMF value.

$${f}_{CM}^{*} ( ω ) = \frac{{ε}_{p}^{*} ( ω ) - {ε}_{m}^{*} ( ω )}{{ε}_{p}^{*} ( ω ) + 2 {ε}_{m}^{*} ( ω )} \qquad ( Equation 1 )$$

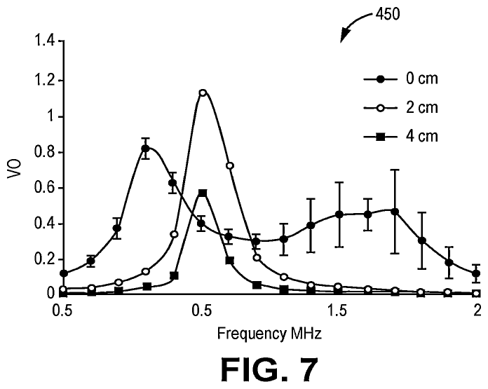

The sign on the real part of the CMF may determine whether the operation is within the positive or negative DEP regimes. For sensing, if pDEP is the target operating regime such that particles are trapped close to the sensing electrodes an operating frequency below the crossover frequency should be used. The CMF of Polystyrene beads in deionized water is plotted in graph 400 of FIG. 6 and the cross-over frequency from pDEP to nDEP is predicted to be 2.58 MHz.

By considering a spherical particle (whose geometry will have the lowest polarizability and thus be the most challenging to actuate) with a radius, R, the classic DEP force equation (Equation 2) depends predominantly on the particle's size (with smaller particles being more difficult to manipulate) and the gradient of the electric field squared, ∇|E|2.

F_{DEP}=πεₘR³Re{f*_{CM}(ψ)}∇|E|² (Equation 2)

In Equation 2, εm is the dielectric constant of the surrounding medium and fCM*(ω) is the complex frequency dependent CMF value. While the gradient of the electric field can be increased to trap smaller particles (e.g. viruses) using higher voltages (e.g., 5 V to 10 V peak voltage), lower operating voltages (e.g., 1 V to 2 V peak voltage) can mitigate electrolytic reactions and thermal heating. Furthermore, higher voltages may require larger power sources, amplifies, and filters which can be costly, bulky, and challenging to integrate with portable devices and/or limits the distance of separation between the transmitting source and trapping device. However, instead of increasing the electric field gradient with higher voltages, a nanoscale dielectric defining a nanogap between the electrodes can increase the electric field gradient. Accordingly, the benefits of an increased electric field gradient can be realized without the downsides of higher voltages.

In one example, an electrode array included a 20-nanometer nanoscale dielectric layer of alumina (Al₂O₃) that defined a gap between two electrodes (e.g., electrode array 201 of FIG. 3). The electrode array was fabricated using atomic layer deposition (ALD). Using ALD may provide precisely control electrode alignment at the nanometer scale over relative larger areas (e.g., square millimeters). Initially, a coplanar electrode arrangement was used to minimize the capacitance (22.2±0.8 picofarads in deionized water) and provide flexibility for tuning the circuit's resonance. The general fabrication process is provided herein with respect to FIGS. 4A-4D.

In another example, an electrode array with a stacked metal-insulator-metal (MIM) micro hole array design was used with a 20-nanometer nanoscale dielectric of Al₂O₃ that defined a gap between two electrodes (e.g., electrode array 101 of FIG. 1A). The stacked MIM micro hole array was fabricated using ALD. The MIM micro hole array increased the number of regions with large electric field gradients (i.e., the micro hole perimeters) to offer more particle collection for sensing applications. Such micro holes may increase sensitivity of a wireless circuit by exposing more fringe field to the particle solution for impedance-based sensing. The general fabrication process for the MIM micro hole array is provided herein with respect to FIG. 2A-2D.

For DEP, the efficiency of actuation work exerted on the particles may directly correlate with how efficient electromagnetic energy is stored as electric fields within an electrode array (Equation 1). Because electrode arrays may be predominantly capacitive, an inductive reactive component can be wired in series or parallel with an electrode array to form a wireless circuit (LCR resonator). Such a resonate wireless circuit may increase an electric potential that can be stored by the device. Furthermore, the inductor can simultaneously serve as an antenna for wireless power transfer (WPT) and resonant wireless power transfer (rWPT). By using another LCR resonator as a transmitting circuit or device, the magnetic fields stored within the inductor of the transmitting device can couple power to the inductor of the wireless circuit to wirelessly power trapping of particles with the electrode array. For efficient WPT, it is desired to maximize the storage of EM energy in the form of magnetic fields in the transmitting device. The EM energy may be maximized under a parallel or series LCR resonator configuration in the transmitting device. Therefore, an efficient WPT or rWPT circuit may include a parallel LCR resonator in the transmitting device and a series LCR circuit in the wireless circuit used for DEP trapping of particles.

In one example, a target frequency of 1 MHz was chosen for Polystyrene beads in deionized water. The resonant frequency for each LCR resonator is provided (Equation 3) and may be used to define resonance at the target operating frequency.

$${f}_{Res} = \frac{1}{2 π \sqrt{L C}} \qquad ( Equation 3 )$$

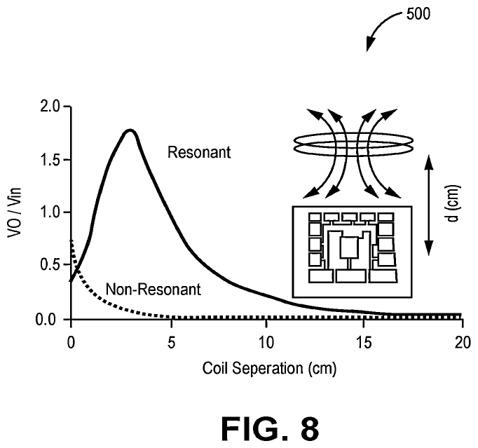

The efficiency of WPT via inductive coupling may depend on the amount of magnetic flux emitted from the transmitter that crosses the receiving inductor. At large distances of separation, d, the coupling is poor resulting in lower voltage dropped across the wireless circuit as compared to shorter distances of separation as shown in the graph 450 of FIG. 7. However, for rWPT there can be a minimum distance in coil separation before strong coupling causes a frequency splitting and thus reduces the voltage dropped across the wireless circuit at the target frequency as shown by the graphed voltages at a distance of 0 centimeters. When the distance of coil separation is below the minimum, the self-inductance of each coil may interfere with the other and causes the two LCR circuits to resonate at shifted frequencies. The shifted frequencies may result in two smaller voltage peaks in frequency space as shown in FIG. 7. Trapping and sensing of particles using pDEP may rely on a fixed target frequency. Accordingly, wireless circuits that include a nanogap or nanoscale dielectric layer between electrodes demonstrate a synergistic effect for DEP trapping of virus-size particles and smaller over poor coupling conditions (e.g., greater than 10 centimeters) using only a digital logic voltage value on a transmitting device. This capability for wireless particle collection under poor coupling distances offers a greater range of applications it can serve as well as a robust platform for broad consumer use.

Resonant, Nano-focusing DEP for Wireless Particle Collection

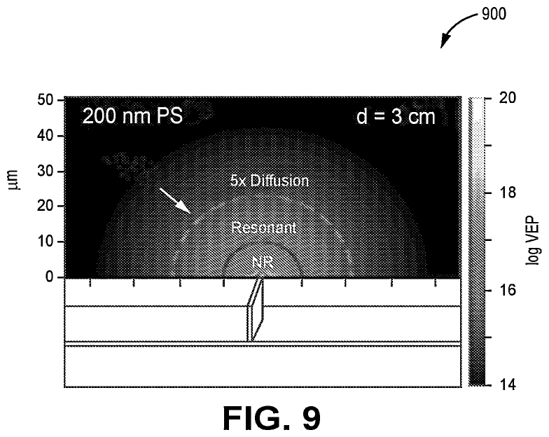

To compare performance, two WPT circuits were made for 1 MHz operation in which one was a resonant wireless circuit and the other a non-resonant wireless circuit. The coupling of voltage over the WPT circuits were measured as a function of coil separation between the inductor of the transmitting device and the inductor of each of the WPT circuits. For the non-resonant wireless circuit, strong coupling was not observed, and the voltage coupled to the non-resonant wireless circuit continually increases as the separation is reduced as shown by graph 500 of FIG. 8. For the resonant wireless circuit, the optimal coil separation was found experimentally between about 3 centimeters where a gain of 1.8 times the nominal input voltage is dropped over the device. Depending on the application, such voltage gain using the wireless resonant circuit can offer larger trapping volumes for more efficient particle collection or robust trapping over larger distance of coil separation compared to the non-resonant circuit.

The trapping volume can be defined in a general sense as the volume in which the DEP force (Equation 2) can significantly manipulate suspended particles. Typically, this may be the volume in which the DEP force is greater than the stochastic forces due to thermal Brownian motion (e.g., thermal trapping volume).

$${F}_{DEP} > \frac{k T}{2 R} \qquad ( Equation 4 )$$

Here, T, is the temperature of the ambient solution, k, is Boltzmann's constant, and R, is the radius of the spherical particle. The distance from the gap at which the gradient of the electric field squared satisfies this condition can be solved for (Equation 5) and defines the thermal trapping radius.

$$∇ {\vert E \vert}^{2} > \frac{k T}{4 π {ε}_{m} {R}^{4} Re \{ {f}_{CM}^{*} \}} \qquad ( Equation 5 )$$

Here, εₘ, is the dielectric constant of the ambient solution and, f_{cm}* is the CMF defined in Equation 4. However, DEP can still exhibit a net bias on particles beyond this distance such that the net movement of the particles towards the gap is n-times faster than diffusion would naturally deliver the particles. This condition on the gradient of the electric field squared becomes the following:

$$∇ {\vert E \vert}^{2} > \frac{n k T}{{T}_{R} π {ε}_{m} {R}^{3} Re \{ {f}_{CM}^{*} \}} \qquad ( Equation 6 )$$

Where, T_{R}, is the distance from the gap in which the gradient of the electric field is evaluated. For larger values of n, the resulting trapping radius at which the electric field satisfies the condition of Equation 6 will be reduced.

Thus, particles can experience a component of DEP beyond the volume where DEP adds a net drift to the particle's diffusion towards the fringe fields where it is eventually trapped. Accordingly, the trapping volume can be extended to include volumes where DEP transports a particle n-times faster than it would take to diffuse the equivalent distance in which larger values for n will result in smaller trapping volumes. An added advantage of DEP collection may be knowledge of the particle's precise location after collection. While both DEP and diffusion can transport the particle over some distance (with DEP being n x faster) given enough time, the final location of the diffused particle is unknown and must be searched for on an image plane.

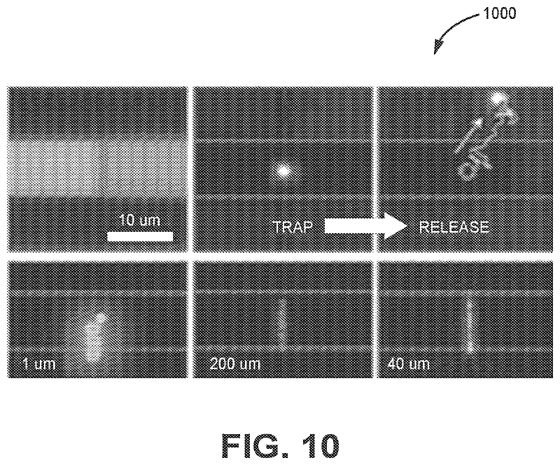

As shown in FIG. 9, the shape of the trapping volume may be cylindrical for coplanar electrodes. The trapping volume may be cylindrical due to the radial decay of the fringe fields from the nanogap defined by the nanoscale dielectric layer. Accordingly, the trapping radius of the cylinder may be a function of the input voltage. Simulation of the relative trapping radii for Polystyrene particles ranging in size of 40 nanometers to 1 micrometer were compared at the optimal coil separation of 3 cm for the resonant and non-resonant circuit using a digital logic input value of 3.5 VRMS at 1 MHz. The thermal trapping radius and a 5 times faster than diffusion (i.e., n=5) trapping radius were calculated and tabulated in Table 1.

| | Non-resonant | Resonant | |
|---|---|---|---|
| Particle Size (nm) | Thermal (μm) | Thermal (μm) | n = 5 (μm) |
| 40 | 0.146 | 1.1 | 2.1 |
| 200 | 1.3 | 9.9 | 22.7 |
| 1,000 | 11.3 | 86.5 | >100 |

Under these conditions, the thermal trapping volume is approximately about 58 times greater using resonant operation as compared to non-resonant and thus results in about 58 times more particles collected for a given concentration. Furthermore, the trapping volume is 200 to 300 times larger when considering the radius in which collection is 5 times faster than diffusion using resonance.

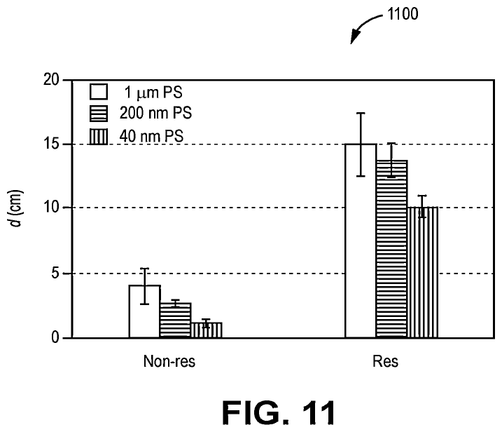

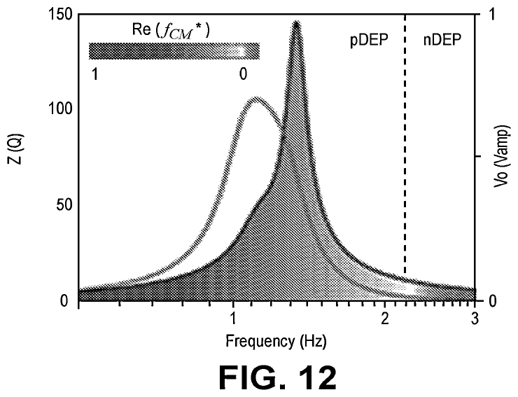

The implications of these results were tested experimentally by finding the furthest coil separation between the inductor of the transmitting device and the inductor of the wireless circuit such that DEP trapping could remain. Because the trapping volume is a function of voltage in which the coupled voltage is a function of coil separation as shown in FIG. 8, resonant wireless circuits may provide relatively long-distance particle trapping compared to non-resonant circuits. Keeping the source voltage to a digital logic value (3.5 VRMS), the coils were brought near to one another to increase the trapping volume and wirelessly trap the target particles at the nanogap as shown in FIG. 10. Once the trap was loaded, the coils were then slowly separated from each other vertically until all the particles were able to thermally diffuse away from the trap site as observed using fluorescent imaging. The maximum distance of separation between coils was compared to a non-resonant case, in which the operating frequency still maintained 1 MHz as shown in FIG. 11. The separation between coils can be nearly 3 times farther using resonant wireless circuits in comparison to non-resonant wireless circuits.

Simultaneous Wireless Particle Detection via Reflected Impedance

In addition to rapid particle collection, electrode arrays with a nanogap defined by a nanoscale dielectric layer can be used to wirelessly detect the presence of trapped particles. As particles replace the surrounding medium near the focused fringe fields of the nanogap, precisely positioned via DEP, the change in the dielectric permittivity and conductivity in this region can shift the total circuit's impedance and be measurable on the transmitting end when utilizing wireless circuits as described herein.

Stacked MIM micro hole arrays with a 20 nanometer thick dielectric layer of Al₂O₃ forming a nanogap were fabricated (e.g., electrode array 101 of FIG. 1A). The size of the array was 600×600 micrometers and the total estimated trapping/edge length from the array and edges is 72.5 millimeters. The array had a capacitance of 1.64±0.02 nanofarads with a resistance of 15.5±0.6 Ohms as measured in deionized water at 1.3 MHz. Such circuit design allowed for low-frequency RF operation. A Network Analyzer was wired in a parallel LCR resonant circuit in the transmitting device to serve as both the wireless power supply and subsequent measurement instrument. The inductor of the transmitting device had an inductance of 1.7 microhenries and the corresponding parallel capacitor was chosen to optimize the new target operating frequency.

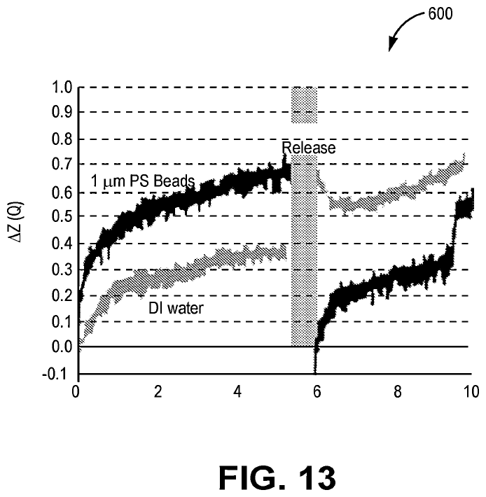

The target operating frequency may be determined by meeting three criteria. First, the target operating frequency should be within the range necessary for pDEP of the target particle as determined by its CMF (Equation 1). For Polystyrene beads in deionized water, this is any frequency within the blue shaded area shown in graph 550 of FIG. 12 (e.g., less than 2.58 MHz). Second, the target frequency should be a frequency such that the transfer function relating the voltage dropped over the wireless circuit is near maximal to maximize the DEP trapping radius. For the peak transfer function to remain within the pDEP domain for the wireless circuit with a MIM electrode array, an inductance of 11 microhenries was chosen. The coil separation between the transmitting device and the wireless circuit was fixed to 2.5 centimeters. The voltage drop across the wireless circuit was wirelessly induced by the transmitting device and measured as a function of frequency where its peak value was found at 1.1 MHz as shown in graph 550. Third, the operating frequency should be in a region of the total impedance spectrum of the wireless circuit that allows measurable impedance changes of the wireless circuit during DEP. Using a simulation, it was found that a primary parallel capacitor of 11 nano-farads offered a change in impedance at a frequency of 1.3 MHz. This frequency was near the transfer function peak shown in graph 550 and, therefore, met all three criteria described herein. Accordingly, 11 nano-farads was chosen as the target operating frequency. Using the such wireless circuit, the impedance spectrum was measured with the transmitting device in deionized water.

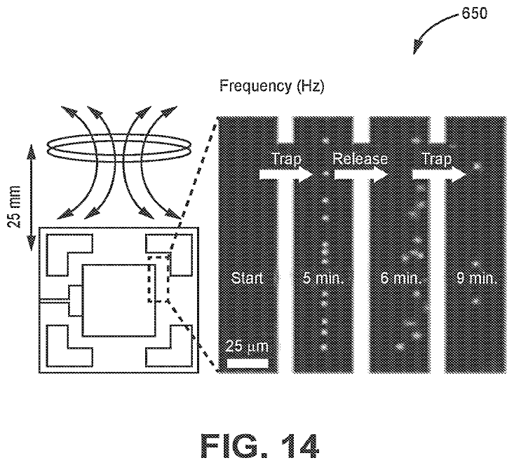

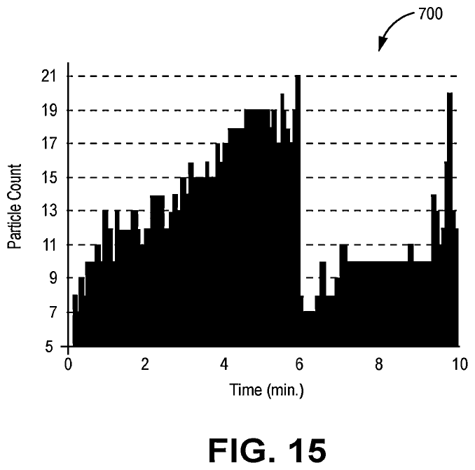

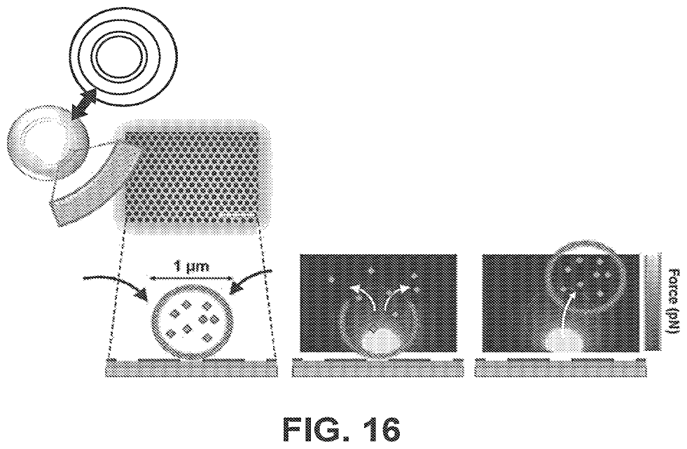

Initially, the impedance of the wireless circuit was measured by the transmitting device with only deionized water placed on the wireless circuit to establish a background signal as shown in graph 600 of FIG. 13. Afterwards, 1 micrometer Polystyrene fluorescent beads were placed into the deionized water. Subsequently, the change in reflected impedance was measured wirelessly by the transmitting device as a function of time as fluorescent imaging confirmed the trapping of beads as shown in FIGS. 13 and 14. After five minutes, power was removed from the transmitting device to allow the Polystyrene beads to be released and empty the microhole traps. After one minute, the power was restored to the transmitting device and trapping was restarted. Using a microscope field of view of 180×135 micrometers (e.g., 7% of the total sensing area), the particle count was recorded in time as shown in graph 700 of FIG. 15 and followed similar trends as the impedance data. This suggests a correlation between the shift in impedance and number of particles present in the sensing volume. In this manner, DEP is used to collect and position target analytes within the high field, sensitive edges of the micro hole array and relay back the change in impedance wirelessly for compact and sample sealed applications.

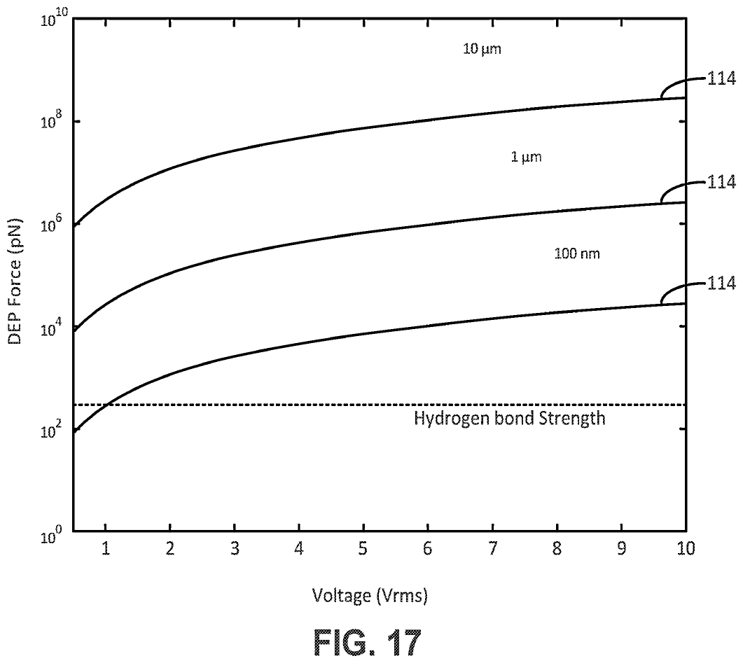

FIGS. 16 and 17 show active drug release using wireless circuits as described herein. Such wireless circuits can be used to release chemically bound drug carrying capsules. Wireless circuits can be integrated with smart contact lens diagnostic devices to provide active and real time drug elution without releasing chemical byproducts and would be reloadable by the patient. Furthermore, with impedance sensing capabilities, two coils (one as reference and the other for sensing) could be used for glucose monitoring in diabetic patients. In response to high glucose levels, drug release could be activated on a need basis and reloaded by the patient at home in their contact solution. Advantages of this sensing and drug release approach include the entire system being passive, thereby wasted power consumption of analog to digital converters and direct current circuits of current smart contact lenses is removed.

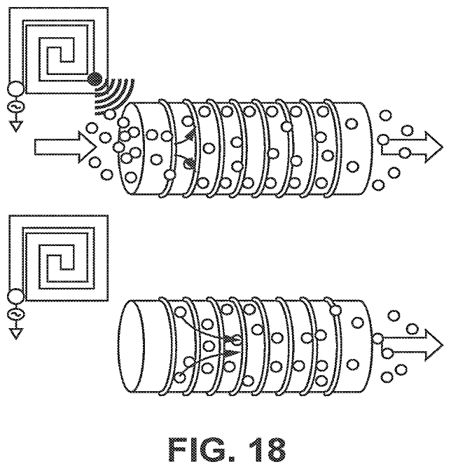

FIG. 18 shows a wireless circuit as described herein being used for the lining of inside microfluidic or liquid tubing to actively filter particles from passing, collect particles to be released later, or stimulate mixing within tubing to enhance chemical reactions.

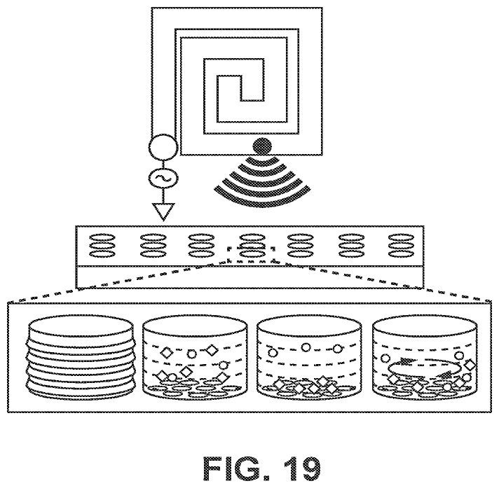

FIG. 19 shows wireless circuit as described herein being used in microwells. In microwells, the wireless circuit can be used to collect particles to be released later or stimulate mixing or stirring within microwells to enhance chemical reactions.

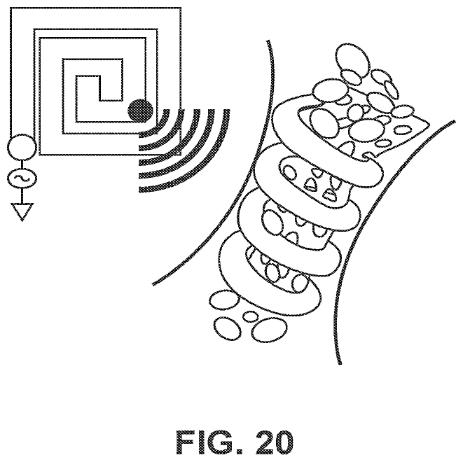

Further, resonant, or non-resonant wireless circuits could be used to cover the surfaces of implantable devices to prevent biofouling. The wireless nature of wireless circuits does not require an additional power to be implanted with the implantable devices. As shown in FIG. 20 the wireless device can prevent re-clotting of stents within the cardiovascular system of patients suffering from vascular stenosis. As compared to passive chemical release stents that eventually wear out, such a device could offer active repelling of plaque particles that could be powered by an external wireless source held near the patient's implant location when so desired. Furthermore, monitoring of the stent's condition could also be fed back to the patient wirelessly to aid medical professionals in decisions for further therapy.

Inductive couplers can additionally be integrated within the chip to provide compact integration. This method may reduce contact resistance and simplify operation. Multiple wireless DEP devices could be fabricated on single chips for high throughput manufacturing. Additionally, it could increase experimentation throughput by offering many devices to be activated in parallel with a single emitting source.

These individual devices could be assigned their own sample wells, or all be integrated into the same sample well. Wireless sensing could further be integrated.

An example of these coils could consist of spiral inductors, clover-leaf resonator, microstrip, open stub or shunt stub transmission lines, ring or split-ring resonators, hairpin resonator, interdigitated electrodes or other integrated inductive coupler designs.

Design parameters should include a low resistance inductive material comprising the resonator structure to maximize inductive wireless coupling. These resonators could be fabricated using standard microfabrication technology (e.g. photolithography or electron beam lithography with lift-off, evaporation or sputtering with etching, etc.), inkjet printing of on-chip inductors via conductive ink, or 3D printing of conductive inductors. Further, doped semiconductors and 2D materials such as graphene could comprise these resonators.

Additionally, the resonator itself could be fabricated on top of the dielectric layer such that the edges of the resonator serve as DEP actuation sites for particle collection, repulsion, electro kinetic mixing or inducing electroosmotic flow.

On-chip Coil Preliminary Data

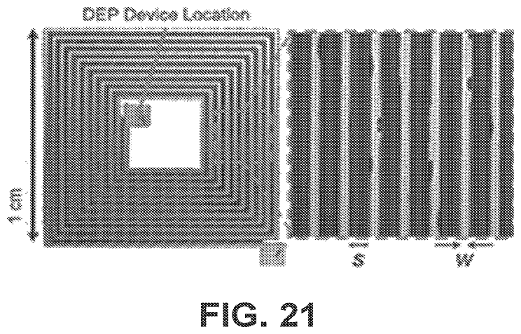

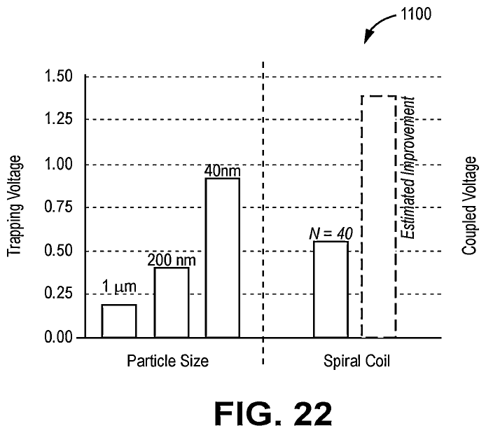

Various on-chip spiral inductors that are 1 centimeter in diameter were fabricated with an example depicted in FIG. 21. A magnified view is depicted showing trace width W and spacing S design parameters. FIG. 22 depicts a bar graph showing the threshold voltage for trapping PS beads in DI water at 1 MHz that were experimentally determined and plotted. The voltage was wirelessly coupled to a 500 picofarad capacitor with a 5 V input signal at 1 MHz and was experimentally measured and found to be enough for trapping 200 nm PS beads or larger.

Initial spiral inductors were fabricated by sputtering 2 μm of Aluminum onto a glass wafer. Photolithography defined spiral patterns in which a wet aluminum etchant was used to etch the pattern into the Aluminum layer. Additionally, ion milling, and reactive ion milling was also used as alternative methods. The spirals of the spiral pattern were 1 centimeter in diameter. Larger diameters may provide better coupling but may be less compact and have a larger resistance. Thus, larger diameters may reduce coupling efficiency. Smaller coils can be packed tighter but may exhibit poorer wireless coupling than larger diameters. In these examples, resonance was designed for 1 MHz input signal (assuming a DEP device capacitance of 500 picofarads). The width W of the traces ranged from 20 to 70 micrometers and spacing S between the traces ranged from 20 to 40 micrometers. The number of turns ranged from 30 to 60 turns that resulted in inductance values that ranged from 10 to 30 microhenries. A 5 V peak voltage at 1 MHz signal was applied to a transmitting LCR circuit with an inductor of 1.7 microhenries and parallel capacitor of 15 nanofarads. The voltage coupled to the model 500 picofarad device was enough to surpass the trapping threshold for 200 nanometer PS beads or bigger. From these results, if the trace widths W were doubled (resulting in the coil diameter increasing to 1.6 centimeters) it is estimated the coupled voltage may be 1.5 times larger. Such an increase in coupled voltage may be sufficient to trap 40 nanometer PS beads or larger.

Frequency-Plexing

Additionally, on-chip, inductive coupler arrays or external inductive coupler arrays may be designed to each resonate at a unique frequency. Accordingly, each coupler may be assigned to one of various electrode structures used for particle manipulation. Such designs may allow for independent control of each device and what locations are activated for wireless particle manipulation or allow all devices and locations to be excited using a single broadband, radio-frequency pulse. In the latter case, each device may be excited in parallel but resonant at their unique frequencies to manipulate those particles that specifically respond to that resonant frequency. Accordingly, a wireless, spatial sorting of particles in solution may be provided.

Each individual wireless device may be assigned their own sample wells, or all be integrated into the same sample well. Wireless sensing could further be integrated in which trapped particles' unique frequency response may be analyzed wirelessly for high-dimensional data acquisition.

Flow-Through Electrode Scheme

Additionally, a flow-through electrode scheme, could benefit from the wireless device, systems, and methods provided herein. The electrode structure of the wireless device may serve as a membrane divide between two reservoirs and facilitate particle interactions between the two reservoirs. Such interactions may include filtering, sorting, trapping, accelerated delivery, or other manipulations.

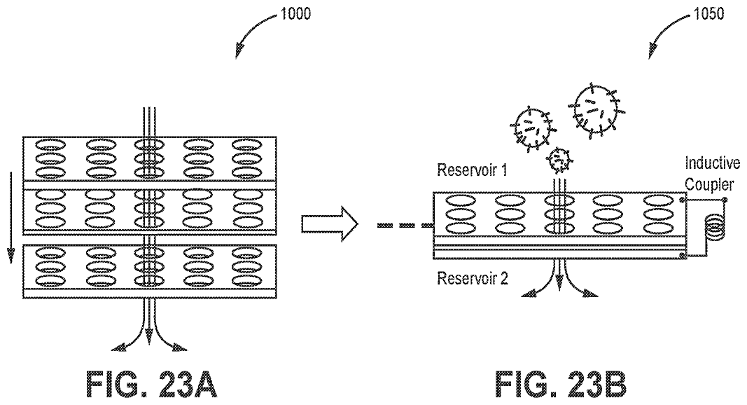

In one or more embodiments, an electrode array of a wireless device as described herein may act as a membrane between two reservoirs. The electrode array may include apertures that extend through the first electrode, the dielectric layer, and the second electrode as depicted in FIG. 23. The apertures may have a nanoscale or microscale width. So arranged, one reservoir may be exposed to a major surface of the second electrode and the other reservoir to a major surface of the first electrode. In some embodiments, the electrode array acting as a membrane may include, for example, a single aperture or one or more pores having a nanoscale or microscale width. The pores may be formed using, for example, track etching.

The electrode structure may be coupled to an inductive coupler at 1050. Resonant or non-resonant wireless power coupled to this device may facilitate the transfer of particles between the two reservoirs through the apertures or pores. Such functionality may provide size-based or frequency-response based filtering, sorting, accelerated delivery, or other interaction between the reservoirs.

Using wireless circuits as described herein, long distance (e.g., 10 centimeters) inductive coupling can be used to trap micrometer to nanometer sized particles wirelessly. Furthermore, wireless feedback can be used for to sense target analytes as they are precisely positioned within high electric field regions of the electrode array of the wireless circuit. The systems and methods described herein may be integrated with biomedical and sensing applications in aqueous environments where electrical connection is not favorable (e.g., liquid tubing, microwell plates, wearable biotech, or implantable technology).

Wireless circuits described herein can be used for at-home, point-of-care (POC), diagnostic devices. In particular, such wireless circuits may be used to target suspended particles in an aqueous solution (e.g., virus, bacteria, protein, etc.). To make such diagnostic devices more accessible, the devices can have an operating voltage that is equal to or less than 5 Volts and operate via wireless power transfer (WPT) as described herein. Such wireless power transfer may enable the diagnostic devices to have portable power supplies, facilitate remote access into isolated regions of interest, and incorporate smartphone integration capable of simultaneously delivering power and performing computation analysis.

While wireless detection poses great advantages for diagnostic devices, the transfer of target analytes to sensing surfaces is typically a diffusion limited process for point-of-care applications. Such diffusion limited processes may result in random analyte placement (filling only a fraction of the sensing elements) and/or may be slow, requiring long wait times. While wireless power transfer for manipulation of specifically engineered microstructures has been demonstrated with great success in micro-robotic operations, the target particles are typically uniquely engineered or chemically tagged to achieve the desired manipulation. In contrast, dielectrophoresis (DEP) actuation can provide active and rapid particle manipulation of arbitrary suspended particles using radio frequency (RF) signals that does not require a particular charge, magnetic moment, or chemical tag. Instead, an electric field gradient driven at an RF frequency can be used to induce a local dipole moment about the particle and collect them within strong fringe field regions surrounding the working electrodes. As particles displace the ambient solution within these focused-fringe-field volumes, a change in reflected impedance can be observed.

Some dielectrophoresis (DEP) based actuation and sensing strategies may utilized voltage signals from about 10 Volts to about 100 V to perform particle collection and thus makes detecting a small signal change from the trapped particles difficult. However, dielectrophoresis (DEP) using nanogap technology as described herein to efficiently confine RF signals for DEP trapping of virus sized particles or smaller with large surface coverage using RF signals of less than 1 Volt. Accordingly, a single low voltage (e.g., less than 5 Volts) signal is necessary for simultaneous trapping and detection of suspended particles. Additional advantages may be realized when utilizing a resonant tank circuit in which the parasitic capacitance of the device is canceled by inductive reactance. Such resonant tank circuit may result in multiplicative voltage gains causing an increase in the number of particles collected and a heightened sensitivity of the resonant mode to impedance changes made from the trapped particles. Such principles can be applied remotely by utilizing the same resonant inductor as an antenna for wireless power transfer via inductive coupling.

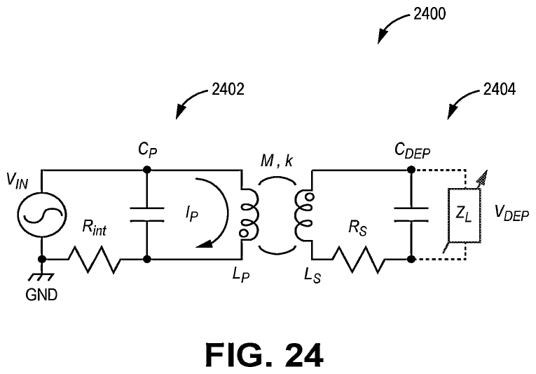

FIG. 24 shows a schematic diagram of a wireless power transfer circuit 2400 including a primary circuit 2402 (containing the power supply) configured to couple electromagnetic power to a secondary circuit 2404 (wired to the dielectrophoresis device) via magnetic fields between a primary inductor, L_{P}, and secondary inductor L_{S}. The mutual inductance of the inductor pair, M, can be represented as shown in Equation 7:

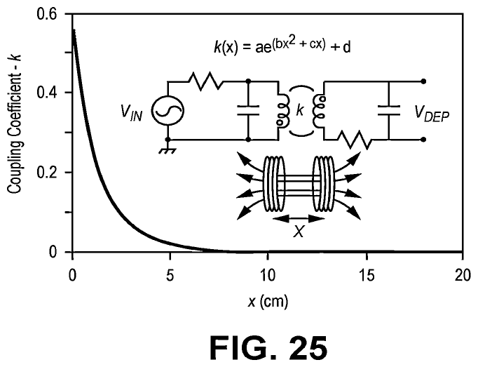

M=k\sqrt{L_{P}L_{S}} (Equation 7)

where, k, is the coupling coefficient and can vary between 0 and 1 depending on the fractional overlap of the two inductors' magnetic flux. The coupling coefficient increases as the separation between the two coils x is reduced until strong coupling effects occur. This can be modeled and fit using an exponential function as shown in FIG. 25 and Equation 8.

k=ae^{bx}^{²}^{+cx}+d (Equation 8)

The coupling coefficient can be approximated as an exponential decay function with coil separation using fitting parameters, a, b, c, and d. Equation 7 relates the coupling coefficient k to the mutual inductance M and thus can be used to fit the experimentally found voltage gain V_{DEP}/V_{IN}.

The dielectrophoresis (DEP) device with a capacitance, C_{DEP}, forms an LCR circuit with the secondary inductor and has a total impedance, Z_{S}. This impedance may be minimized when the angular operating frequency is equivalent to the resonant frequency of the secondary wireless power transfer circuit 2404 as shown by Equation 9.

$${ω}_{0} = \frac{1}{\sqrt{{L}_{S} {C}_{DEP}}} \qquad ( Equation 9 )$$

The voltage V_{DEP} across the dielectrophoresis (DEP) device used to generate the field gradient in Equation 2 may depend on the mutual inductance (Equation 7) and the current carrying power through the primary inductor I_{P} as shown in Equation 10.

$${V}_{DEP} = \frac{M}{{C}_{DEP} {Z}_{s}} {I}_{P} \qquad ( Equation 10 )$$

The voltage VDEP may be maximized when Z_{S} is minimized (e.g., the driving signal is operated at the resonant frequency (Equation 9). However, the current through the primary inductor I_{P} may also experience a component of reflected impedance Zᵣ that is inversely proportional to Z_{S} as shown in Equation 11.

$${Z}_{r} = \frac{{( ω M )}^{2}}{{Z}_{s}} \qquad ( Equation 11 )$$

Accordingly, it may be advantageous to configure the primary circuit 2402 as an LC resonator in which a parallel configuration can promote current gains I_{P} through the transmitting primary inductor to compensate. Such configuration may result in the current I_{P} being defined by Equation 12:

$${I}_{P} = \frac{{V}_{IN}}{{Z}_{IN}} ( \frac{ⅆ {jX}_{CP}}{ⅆ {jX}_{CP} + {jX}_{LP} + {Z}_{r}} ) \qquad ( Equation 12 )$$

where X_{LP} and X_{CP} are the reactance of the primary inductor and capacitor, respectively. The input voltage V_{IN} from the power source may see a total input impedance Z_{IN} as shown in Equation 13 which includes its internal resistance Rᵢₙₜ (typically standardized to 50 Ω).

$${Z}_{IN} = {R}_{int} + \frac{{jX}_{CP} ( {jX}_{LP} + {Z}_{r} )}{{jX}_{CP} + {jX}_{LP} + {Z}_{r}} \qquad ( Equation 13 )$$

Detection of trapped particles with a load impedance Z_{L} can then be observed through Z_{IN} as a change in the reflected impedance, Zᵣ (Equation 11), of the secondary circuit 2404 impedance Z_{S} as shown in Equation 14.

$${Z}_{S} = {R}_{S} + {jX}_{LS} + \frac{{jX}_{DEP} {Z}_{L}}{{jX}_{DEP} + {Z}_{L}} \qquad ( Equation 14 )$$

The secondary circuit 2404 impedance is in the series LCR configuration with a series resistance R_{S}, inductive reactance X_{LS}, and dielectrophoresis (DEP) device capacitive reactance X_{DEP}, that is in parallel with the load impedance Z_{L} that changes in time as particles are trapped.

As shown by Equations 7, 8, and 10, reducing the distance between the coils (i.e., x→0),

may result in a larger voltage V_{DEP} across the dielectrophoresis (DEP) device due to a better coupling coefficient k. However, when operating at the resonant frequency, the coupling can become too large and result in a strong coupling regime. Such strong coupling regime may cause a frequency splitting of the wireless power transfer function away from the resonant operating frequency wo and the overall performance may be reduced. Experimentally, this strong coupling regime was found to determine the optimal distance of separation for wireless power transfer using the coplanar dielectrophoresis (DEP) device. Equations 7-14 were used to empirically fit our experimental results using a non-linear least squares approximation with the coupling coefficient, k, and particle load impedance Z_{L} as fitting parameters.

To experimentally characterize the voltage transfer function, no particle load Z_{L} was used. Thus, the secondary circuit impedance Z_{S} became:

Z_{S}=R_{S}+X_{LS}+X_{DEP} (Equation 15)

where R_{S} is the series resistance, X_{LS} is the inductive reactance, and X_{DEP} is the dielectrophoresis (DEP) device capacitive reactance. An operating frequency of 1 MHz at 0.707 VRMS (V_{IN}=0.707 V_{RMS}) was used during data collection (data of FIG. 8) and the following circuit parameters Rᵢₙₜ=50 Ω, C_{P}=15 nF, L_{P}=1.68 μH, L_{S}=1.8 μH, and R_{S}=0.2 Ω. The resonant wireless power transfer (WPT) circuit with such parameters had a total C_{DEP}=14.022 nF (22 pF DEP device in parallel with an additional 14 nF) and the non-resonant wireless power transfer (WPT) circuit had a total C_{DEP}=37 pF (22 pF DEP device in parallel with an additional 15 pF). Using a non-linear least squares fitting function, Equation 8 was fit using Equations 10-13 and the circuit parameters set forth above to the experimental data found in FIG. 8. This resulted in fitting parameters a=0.6, b=244 m⁻², c=−81.5 m, and d=0.0009 and the exponential function of the coupling coeffect k as a function of distance using these parameters is shown in FIG. 25. This function of k then provided the simultaneous fit for both the resonant and non-resonant data in FIG. 8.

Experimental Data

Coils for long-distance dielectrophoretic trapping were designed to compare resonant and non-resonant operations at 1 MHz operating frequency. The coils' outer diameter was 3.5 centimeters and the inner diameter was 3 centimeters. The coils' included five turns of 18 AWG magnetic copper wire wound in a spiral. The primary coil was measured as Lₚ=1.68 microhenries at 1 MHz and a 15 nano-farads parallel compensated network capacitor was added for resonance at 1 MHz. The secondary coil was measured as Lₛ=1.8 microhenries at 1 MHz and a 14 nano-farads compensated network capacitor was added for resonance at 1 MHz.

Another coil was designed for wireless sensing using a parallel-series compensation network. The secondary side inductor included 20 turns of 20 AWG magnetic copper wire wound in a spiral. The inner diameter was 0.5 centimeters and the outer diameter was 5 centimeters. The secondary coil was measured as Lₛ=11 microhenries. Based on the parallel-series compensation network design of the wireless power transfer (WPT) circuit, the primary capacitor was designed with consideration for the equivalent impedance of the dielectrophoresis (DEP) sensor. Absolute Particle Velocity With and Without Wireless Trapping

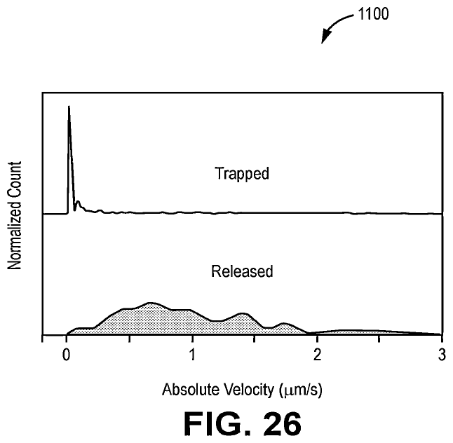

Prior to wireless trapping and detection, a 30 second baseline recording of the particle velocity was made using fluorescent imaging with 1 second frames (2×2 pixel binning, 400 milliseconds exposure). Suspended 1 micrometer polystyrene beads were seen to randomly diffuse prior to wireless actuation with an average absolute particle diffusion velocity of 1.094±0.340 micrometers per second as shown in FIG. 26. After applying the network analyzer to the transmitting coil, particles were wirelessly trapped resulting in the majority of the particle velocities being reduced to ˜15 nanometers per second. Particles were considered trapped if they held a velocity less than three standard deviations below the diffusion velocity. Over five minutes of trapping, 88.7% of the recorded particles held a velocity below 73 nanometers per second and were considered trapped.

By combining an efficient nanogap electrode array with resonant wireless power transfer (WPT), a single measurement signal can be used to simultaneously collect and position sub-micron particles within high fringe field regions of a nanogap electrode and relay back the change in impedance wirelessly. This was demonstrated experimentally using inductive coupling between a parallel-series circuit architecture. Robust trapping of virus-sized particles could be maintained with a greater than 10 centimeter separation between the coils using a digital 3.5 V_{RMS} RF signal at 1.3 MHz. Wireless feedback of the impedance change from the rapidly trapped particles could be simultaneously detected at a coil separation of 2.5 centimeters when using a Network Analyzer to supply both trapping and detection without any external amplification or filtering. Such nanogap electrode array with resonant wireless power transfer (WPT) can be integrated into point-of-care and aquatic sensing devices and applications where wired electrical power supplies and/or detectors may not be favorable such as, e.g., liquid tubing, microwell plates, wearable biotech, or implantable technology.

In the following, non-limiting examples are presented, which describe various embodiments of the articles, systems and methods discussed above.

Example Ex1: A wireless circuit comprising:
an electrode array comprising:
a first electrode;
a second electrode;
a dielectric layer between the first and second electrode having a nanoscale or microscale width; and
an inductive coupler operatively coupled to the electrode array and configured to receive wireless power or wireless signals.

Example Ex2: The wireless circuit as in example Ex1, wherein the second electrode comprises a first major surface and a second major surface, the second major surface being disposed on the nanoscale dielectric layer, the second electrode comprising a plurality of apertures extending from the first major surface to the second major surface, the plurality of apertures having a nanoscale or microscale width.

Example Ex3: The wireless circuit as in example Ex1, wherein the first and second electrode are coplanar, interdigitated, or both.

Example Ex4: The wireless circuit as in any one of the previous examples, wherein the nanoscale dielectric layer has a thickness of Ex1 nanometer to less than Ex1 micrometer.

Example Ex5: The wireless circuit as in any one of the previous examples, wherein the nanoscale dielectric layer has a thickness of Ex5 nanometers to Ex100 nanometers.

Example Ex6: The wireless circuit as in any one of the previous examples, wherein the nanoscale dielectric layer has a thickness of Ex10 nanometers to Ex20 nanometers.

Example Ex7: The wireless circuit as in example Ex2, wherein each of the plurality of apertures has a width or diameter of Ex10 nanometers to Ex100 micrometers.

Example Ex8: The wireless circuit as in example Ex2, wherein each the plurality of apertures has a width or diameter of Ex900 nanometers to Ex50 micrometers.

Example Ex9: The wireless circuit as in example Ex2, wherein each of the plurality of apertures has a width or diameter of Ex1 micrometer to Ex10 micrometers.

Example Ex10: The wireless circuit as in any one of the previous examples, wherein the wireless circuit further includes a tuning capacitor or inductor.

Example Ex11: The wireless circuit of any one of the previous examples, wherein the wireless circuit is disposed in a device.

Example Ex12: The wireless circuit as in example Ex11, wherein the device is an implantable medical device.

Example Ex13: The wireless circuit as in example Ex11, wherein the device is a microwell.

Example Ex14: The wireless circuit as in any one of the previous examples, wherein the dielectric layer is an air gap.

Example Ex15: A method comprising:
disposing a first electrode comprising a first major surface and a second major surface;
disposing a nanoscale dielectric layer on the first major surface of the first electrode;
disposing a second electrode on the nanoscale dielectric layer, the second electrode comprising a first major surface, a second major surface; and
operatively coupling an inductive coupler between the first electrode and the second electrode.

Example Ex16: A method comprising:
disposing a first electrode on a portion of a substrate;
disposing a nanoscale dielectric layer on another portion of the substrate and the first electrode;
disposing a second electrode on the nanoscale dielectric layer such that the first and second electrodes are coplanar with each other and the nanoscale dielectric layer forms a nanoscale gap between the first and second electrodes; and
operatively coupling an inductive coupler between the first electrode and the second electrode.

Example Ex17: The method as in example Ex15, further comprising forming a plurality of apertures through the second electrode, wherein the plurality of apertures extend from first major surface of the electrode to the second major surface of the second electrode, wherein the plurality of apertures have a nanoscale or microscale width.

Example Ex18: The method as in example Ex17, wherein the plurality of apertures are formed the first electrode, the dielectric layer, and the second electrode.

Example Ex19: The method as in any one of examples Ex15 to Ex18, wherein the nanoscale dielectric layer is deposited using atomic layer deposition.

Example Ex20: The method as in example Ex16, wherein the nanoscale dielectric layer is deposited such that the nanoscale dielectric layer conformally coats the first electrode and the other portion of the substrate.

Example Ex21: The method as in any one of examples Ex16 or Ex20, further comprising removing excess material disposed on the nanoscale dielectric layer prior to operatively coupling the inductive coupler.

Example Ex22: The method as in any one of examples Ex15 or Ex17, wherein forming the plurality of apertures through the second electrode comprises:
defining an aperture pattern using photolithography; and
etching the plurality of apertures.

Example Ex23: The method as in any one of examples Ex16 or Ex17 to Ex19, wherein the electrodes are interdigitated.

Example Ex24: The method as in any one of examples Ex15 to Ex23, further comprising electrically coupling a tuning capacitor or inductor to the first and second electrode.

Example Ex25: A method comprising:
providing wireless power to an inductive circuit of a wireless circuit, the wireless circuit comprising the inductive circuit operatively coupled to a first electrode and to a second electrode, the first electrode and second electrode separated by a nanoscale or microscale dielectric layer or gap;
generating an electric field using the wireless circuit; and
moving one or more particles using the generated electric field.

Example Ex26: The method as in example Ex25, wherein moving one or more particles comprises the trapping or repelling the one or more particles.

Example Ex27: The method as in example Ex25, wherein moving the one or more particles comprising stirring the one or more particles.

Example Ex28: The method as in any one of examples Ex25 to Ex27, wherein the second electrode comprises a first major surface and a second major surface and comprises a plurality of apertures extending from the first major surface to the second major surface, the plurality of apertures having a nanoscale or microscale width.

Example Ex29: The method as in any one of examples Ex25 to Ex27, wherein the first electrode and the second electrode are coplanar, interdigitated, or both.

Example Ex30: The method as in any one of examples Ex25 to Ex29, further comprising wirelessly sensing particles using a wireless sensing device.

Example Ex31: The method as in example Ex30, wherein the wirelessly sensed particles comprise trapped particles.

Example Ex32: The method as in any one of examples Ex30 or Ex31, wherein the wireless sensing device provides the wireless power to the wireless circuit.

Thus, embodiments of WIRELESSLY POWERED ELECTRIC ACTUATION OF PARTICLES AND MOLECULES are disclosed. One skilled in the art will appreciate that the articles, systems and methods described herein can be practiced with embodiments other than those disclosed. The disclosed embodiments are presented for purposes of illustration and not limitation.

All patents, patent documents, and references cited herein are incorporated in their entirety as if each were incorporated separately. This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the apparatus and methods described herein. Various modifications of the illustrative embodiments, as well as additional embodiments of the disclosure, will be apparent upon reference to this description.

1. A wireless circuit comprising:
an electrode array comprising:
a first electrode;
a second electrode;
a dielectric layer between the first and second electrode having a nanoscale or microscale width; and
an inductive coupler operatively coupled to the electrode array and configured to receive wireless power or wireless signals.

2. The wireless circuit of claim 1, wherein the second electrode comprises a first major surface and a second major surface, the second major surface being disposed on the nanoscale dielectric layer, the second electrode comprising a plurality of apertures extending from the first major surface to the second major surface, the plurality of apertures having a nanoscale or microscale width.

3. (canceled)

4. (canceled)

5. (canceled)

6. The wireless circuit of claim 1, wherein the nanoscale dielectric layer has a thickness of 10 nanometers to 20 nanometers.

7. (canceled)

8. (canceled)

9. The wireless circuit of claim 2, wherein each of the plurality of apertures has a width or diameter of 1 micrometer to 10 micrometers.

10. The wireless circuit of claim 2, wherein the wireless circuit further includes a tuning capacitor or inductor.

11. The wireless circuit of claim 1, wherein the wireless circuit is disposed in a device.

12. The wireless circuit as in claim 11, wherein the device is an implantable medical device.

13. The wireless circuit as in claim 11, wherein the device is a microwell.

14. The wireless circuit of claim 1, wherein the dielectric layer is an air gap.

15. A method comprising:
disposing a first electrode comprising a first major surface and a second major surface;
disposing a nanoscale dielectric layer on the first major surface of the first electrode;
disposing a second electrode on the nanoscale dielectric layer, the second electrode comprising a first major surface, a second major surface; and
operatively coupling an inductive coupler between the first electrode and the second electrode.

16. A method comprising:
disposing a first electrode on a portion of a substrate;
disposing a nanoscale dielectric layer on another portion of the substrate and the first electrode;
disposing a second electrode on the nanoscale dielectric layer such that the first and second electrodes are coplanar with each other and the nanoscale dielectric layer forms a nanoscale gap between the first and second electrodes; and
operatively coupling an inductive coupler between the first electrode and the second electrode.

17. The method of claim 15, further comprising forming a plurality of apertures through the second electrode, wherein the plurality of apertures extend from first major surface of the electrode to the second major surface of the second electrode, wherein the plurality of apertures have a nanoscale or microscale width.

18. The method of claim 17, wherein the plurality of apertures are formed the first electrode, the dielectric layer, and the second electrode.

19. (canceled)

20. The method of claim 16, wherein the nanoscale dielectric layer is deposited such that the nanoscale dielectric layer conformally coats the first electrode and the other portion of the substrate.

21. (canceled)

22. (canceled)

23. (canceled)

24. The method of claim 15, further comprising electrically coupling a tuning capacitor or inductor to the first and second electrode.

25. A method comprising:
providing wireless power to an inductive circuit of a wireless circuit, the wireless circuit comprising the inductive circuit operatively coupled to a first electrode and to a second electrode, the first electrode and second electrode separated by a nanoscale or microscale dielectric layer or gap;
generating an electric field using the wireless circuit; and
moving one or more particles using the generated electric field.

26. The method of claim 25, wherein moving one or more particles comprises the trapping or repelling the one or more particles.

27. The method of claim 25, wherein moving the one or more particles comprising stirring the one or more particles.

28. (canceled)

29. (canceled)

30. The method of claim 25, further comprising wirelessly sensing particles using a wireless sensing device.

31. (canceled)

32. The method of claim 30, wherein the wireless sensing device provides the wireless power to the wireless circuit.
